(19) United States
(12) Patent Application Publication
(10) Pub. No.: US 2002/0042724 A1
(43) Pub. Date: Apr. 11, 2002

(54) Method for delivering healthcare services

(76) Inventor: Corinne Gerbig Victor, Southfield, MI (US)

Correspondence Address: Adam B. Strauss, DYKEMA GOSSETT PLLC, Suite 300, 39577 Woodward Avenue, Bloomfield Hills, MI, 48304, US

(21) Appl. No.: 09/904,813

(22) Filed: Jul. 13, 2001

Related U.S. Application Data
(60) Provisional application No. 60/238,412, filed on Oct. 6, 2000.

(51) Int. Cl. G06F 17/60

(52) U.S. Cl. 705/2

(57) ABSTRACT

A method for delivery of healthcare services is provided. In a facility having a first doctor assigned to a first area to provide healthcare services to patients, the inventive method includes the step of assigning a second doctor to a second area to provide healthcare services to non-emergent patients. The inventive method may further include the steps of recording the time of a patient's arrival; identifying whether the patient is emergent or non-emergent; assigning the patient to an area, based on the emergent or non-emergent status of the patient, to receive healthcare services from a doctor; reviewing the time of the doctor's examination of the patient; and providing compensation to the patient if the time of the doctor's examination is longer than a set period of time after the patient's arrival.

### RELATED APPLICATIONS

This application claims the benefit of U.S. provisional application Ser. No. 60/238,412 filed Oct. 6, 2000, which is hereby incorporated by reference in its entirety.

### BACKGROUND OF THE INVENTION

1. Technical Field

The present invention relates generally to delivering healthcare services, and, in particular, to an improved method for providing healthcare services to patients with emergent and non-emergent conditions.

2. Description of Related Art

Patients arriving at hospital emergency departments for healthcare services desire to be examined by a physician and have a plan of care initiated as expeditiously as possible. In managing healthcare services, hospital emergency departments prioritize resources for patients who arrive with emergent conditions, such as chest pains, respiratory difficulties, stroke symptoms, and other life-threatening symptoms. These emergent patients clearly present superior medical needs than patients with non-emergent conditions, such as sprains and minor lacerations. Nevertheless, conventional methods for delivering healthcare services unnecessarily delay in providing such services to non-emergent patients, notwithstanding that some non-emergent patients may require a shorter time period for examination and treatment as compared with other patients.

Under traditional methods for delivering healthcare services in a hospital emergency department, a non-emergent patient with an ankle sprain, for example, would arrive at the emergency department and write his/her name, age, and chief complaint on a log located at a reception area. While the emergency department may attempt to maintain the confidentiality of the patient's name and complaint by redacting the information, later arriving patients would often be privy to earlier patients' data when signing the log before redactions could be made.

After signing the log, the non-emergent patient typically would be triaged in order to classify the severity of his/her condition, and would wait alongside other patients waiting for triage and treatment. Triage is usually performed by a limited number of emergency department clinicians, often only one or two, who must assess each of the patients waiting to receive healthcare services. Under this method, non-emergent patients are often required to wait extensive periods of time, even upwards of 2 to 8 hours prior to triage, since later arriving patients with more acute conditions, such as chest pains, would be prioritized. When eventually called for triage, the assessment could add an additional time to the non-emergent patient's wait to see a doctor.

Following triage, a patient customarily must complete, in significant part or entirely, his/her registration with the hospital. The registration process includes providing additional personal information, executing a general consent form for treatment, receiving an identification band, assembling a patient's chart and other clerical and administrative procedures. The registration process adds additional time to the delay leading to an examination by a physician.

After registration, a patient is often required to wait for an emergency department room to become available. Under this traditional system, rooms are prioritized based on the patient's triage assessment. The time that a patient arrived for treatment has not traditionally been a determining factor for room assignments, even for patients within the same triage classification. Accordingly, a non-emergent patient may be required to wait an additional period of time of one hour or more prior to receiving a room assignment.

Upon being assigned and escorted to an available room, a patient's chart is placed in a location, such as a designated wall file, to inform a physician that the patient is present and available for examination. Although at this point charts for patients may, for the first time, be arranged in chronological order, conventional methods do not ensure that physicians will examine patients in this order. Therefore, a non-emergent patient is often required to wait an additional period of time, such as 45 minutes to an hour, before being examined by a physician and receiving a plan of care.

Under conventional methods for providing healthcare services, significant obstacles have often led to inefficiencies in treating emergency department patients. First, patients must undergo a rigid sequential process, including triage, registration, and waiting for a room assignment, prior to being examined by a doctor. Second, non-emergent patients are usually provided healthcare services only after treatment is provided to emergent patients. Third, emergency departments do not customarily consider the length of time non-emergent patients wait prior to receiving an examination from a physician.

Accordingly, there is a need for an improved method of delivering healthcare services to patients with emergent and non-emergent conditions.

### SUMMARY OF THE INVENTION

The present invention provides a method for delivering healthcare services to patients, such as in a hospital emergency department.

A method in accordance with the present invention includes the step of providing, in a facility having a first area configured to provide healthcare services to patients, a second area configured to provide healthcare services to non-emergent patients. A doctor is assigned to the second area to provide healthcare services to non-emergent patients. The method also includes the step of identifying whether a patient who arrives to receive healthcare services is non-emergent. The identification step may be performed by a medical clinician, and may be performed upon arrival of the patient at the facility. The method also includes the step of recording the time the patient arrives at the facility to receive healthcare services. The method further includes the step of queuing non-emergent patients to receive an examination by a doctor by time of the patients' arrival. Finally, the method may include the step of providing the patient a form of compensation if the patient first receives healthcare services from a doctor more than a predetermined amount of time after the patient's arrival at the facility.

A method for delivering healthcare services in accordance with the present invention represents a significant improvement as compared with conventional methods. First, the inventive method improves the efficiency of delivering healthcare services by identifying non-emergent patients who may require a shorter time period for examination and treatment as compared with other non-emergent and emergent patients. Second, the inventive method improves the efficiency of delivering healthcare services by allowing patients to receive healthcare services prior to, or in parallel with, completing steps traditionally completed in a sequential manner, such as registration and triage. Third, methods consistent with the invention involve consideration of the length of time non-emergent patients have waited prior to receiving an examination from a physician. The inventive method, in one embodiment, provides the patient a form of compensation if the patient first receives an examination from a doctor more than a predetermined amount of time (e.g., 30 minutes) after the patient's arrival at the healthcare facility. This has the effect of inducing at least a portion of the population in need of healthcare services to patronize such a facility.

These and other advantages of this invention will become apparent to one skilled in the art from the following detailed description and the accompanying drawings illustrating features of this invention by way of example.

### BRIEF DESCRIPTION OF THE DRAWINGS

FIG. 1 is a flow diagram of one embodiment of a method for delivery of healthcare services according to the present invention.

FIG. 2 is a diagram of a floor plan for a hospital emergency department employing one embodiment of the present invention.

### DETAILED DESCRIPTION OF THE PREFERRED EMBODIMENTS

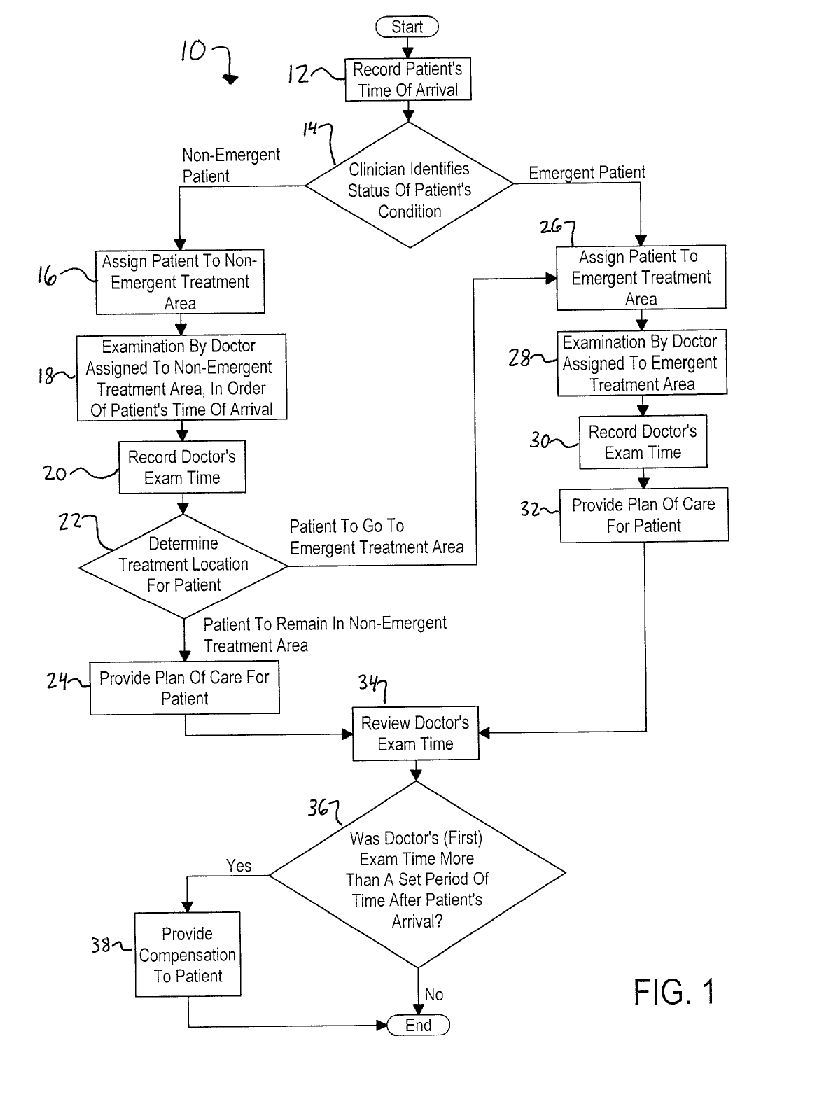

Referring now to the drawings wherein like reference numerals are used to identify identical components in the various embodiments, FIG. 1 is a flow diagram of a method 10 for delivering healthcare services in accordance with one embodiment of the present invention. Healthcare services as used herein may include an examination, diagnosis, plan of care, medication, or treatment provided by a medical doctor or physician (hereinafter “doctor”), nurse, paramedic, advanced emergency medical technician, emergency department technician or any medically trained clinician.

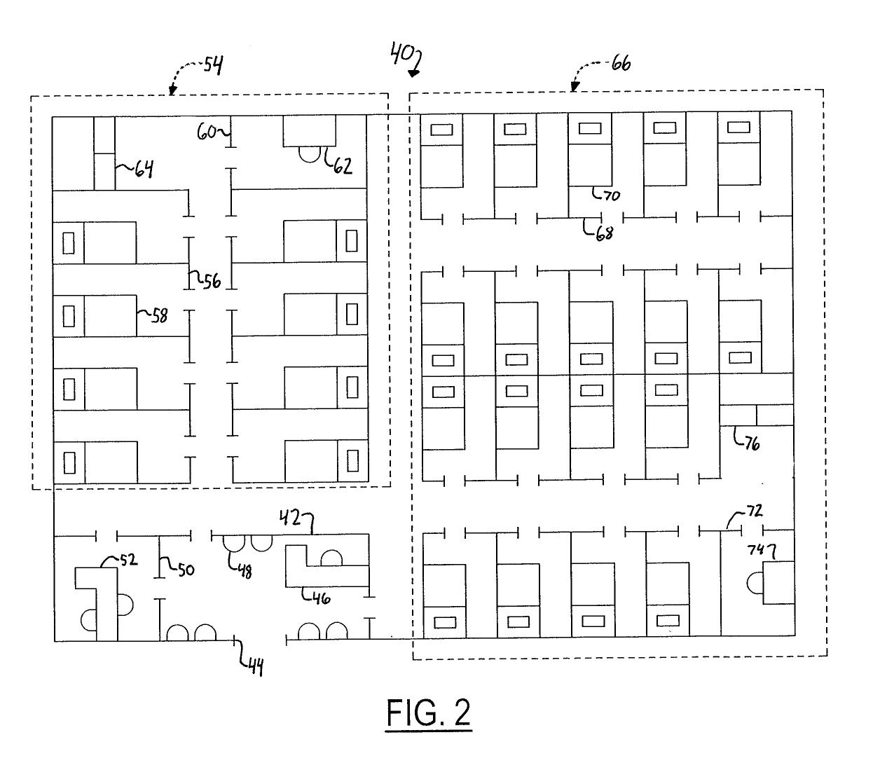

FIG. 2 is a diagram of a floor plan for a hospital emergency department 40 employing one embodiment of method 10. While method 10 is described herein with respect to hospital emergency department 40, it will be appreciated by those skilled in the art that the inventive method is not limited to a hospital setting, and may be applicable to any facility at which patients arrive to receive healthcare services in a substantially random order with respect to severity of condition including, but not limited to, doctors' offices, medical clinics, dentist offices, and veterinary hospitals.

Referring to FIG. 2, hospital emergency department 40 includes a lobby 42, a registration area 50, a first treatment area for treating patients, designated area 66, and a second treatment area for treating non-emergent patients, designated area 54.

Lobby 42 is provided as an entry place to emergency department 40 for patients. Patients arriving by their own accord may enter thorough doorway 44. It will be appreciated by those skilled in the art that patients who arrive at emergency department 40 by ambulance or other emergency service vehicle may enter emergency department 40 at an alternate area. Lobby 42 may include a desk 46 staffed by emergency department personnel, and chairs 48 for patients and families, friends, or escorts of patients.

Registration area 50 is provided as a location to register patients. Registration area 50 may include a registration desk 52 for a registrar. Because of the improved efficiency in providing healthcare services pursuant to method 10, the process for registering a patient may not necessarily be completed before a physician examines a patient.

Non-emergent treatment area 54 is provided as a location to provide healthcare services to non-emergent patients. Non-emergent treatment area 54 may include one or more treatment rooms 56, a doctor's station 60, and a clipboard rack 64. Non-emergent treatment rooms 56 are provided as locations to provide healthcare services to non-emergent patients. Non-emergent treatment rooms 56 may include one or more patient beds 58. Non-emergent treatment rooms 56 may be private rooms separated by full walls, semi-private rooms separated by curtains or other partitions, or an open ward of one or more beds 58.

Non-emergent doctor's station 60 is provided for use by one or more physicians assigned to area 54 to provide healthcare services to non-emergent patients. Non-emergent doctor's station 60 may include one or more desks 62 for use by physicians in, among other activities, reviewing patient charts. Clipboard rack 64 is provided for displaying clipboards containing charts and forms of non-emergent patients in non-emergent treatment rooms 56.

Treatment area 66 is provided as a location to provide healthcare services to emergency department patients, including emergent patients. Treatment area 66 may include one or more treatment rooms 68, a doctor's station 72, and a clipboard rack 76. Treatment rooms 68 are provided as locations to provide healthcare services to patients. Treatment rooms 68 may include one or more patient beds 70. Treatment rooms 68 may be private rooms separated by full walls, semi-private rooms separated by curtains or other partitions, or an open ward of one or more beds 70.

Doctor's station 72 is provided for use by one or more physicians assigned to area 66 to provide healthcare services to patients, including emergent patients. Doctor's station 72 may include one or more desks 74 for use by physicians in, among other activities, reviewing patient charts. Clipboard rack 76 is provided for displaying clipboards containing patient data forms of emergent patients in treatment rooms 68.

With continued reference to FIG. 2 and referring to FIG. 1, the embodiment of method 10 will be discussed as applied in the context of a hospital, such as emergency department 40. In the illustrated embodiment, a method for delivering healthcare services according to the present invention may include the step assigning a first doctor to a first area 66 for providing healthcare services to patients, including emergent patients, and assigning a second doctor to a second area 54 for providing healthcare services to non-emergent patients. Method 10 may further include the steps of recording the time of a patient's arrival 12; identifying whether the patient is emergent or non-emergent 14; assigning the patient to an area (i.e., either area 54 or 66), based on the status of the patient, to receive healthcare services from a doctor 16, 26; reviewing the time of the doctor's examination of the patient 34; and providing compensation to the patient if the time of the doctor's examination occurred later than a set period of time after the patient's arrival 38. In a constructed embodiment, the set period of time was about 30 minutes and the compensation was non-monetary (e.g., a pair of movie tickets).

Method 10 may begin with the arrival of a patient at hospital emergency department 40. A patient who was not transported to emergency department 40 by an emergency vehicle, such as an ambulance, may enter lobby 42 through doorway 44. The patient may be greeted by a greeter at lobby front desk 46. The greeter may be a medically trained clinician, such as a nurse, paramedic, advanced emergency medical technician, emergency department technician, patient representative, and the like. Upon the arrival of a patient, the greeter begins a shortened process for an initial registration of the patient.

The greeter may give to the patient, or patient's escort, a patient data form to complete for obtaining and recording patient information. Alternatively, if the patient or patient's escort are unable to complete the patient data form, the greeter or another emergency department staff member may verbally obtain the necessary information. Information supplied by the patient or otherwise obtained from the patient (e.g., from the patient's escort, or information taken from the patient's wallet, purse, or other personal property), such as the patient's name, address, gender, marital status, telephone number, social security number, family doctor, and chief complaint, is recorded on the patient data form. The information on the patient data form may be duplicated for efficiently managing the delivery of healthcare services. The duplication may occur through carbon or non-carbon sheets attached behind the patient data form to create duplicate sheets while information is recorded on the patient data form. The duplication may also occur through photocopying, electronic, or other conventional means for duplicating information. The duplicate sheets may be different colors which may, among other advantages, provide an immediate visual cue as to information regarding the patient.

The patient data form may also be used in place of the conventional patient log. This improves the confidentiality of a patient's identity and medical information as, unlike the log, the patient data forms would not be viewable at emergency department front desk 46 by later arriving patients. Additionally, the patient data form does not require information concerning the patient's method of payment for healthcare services, as that information may be obtained at a later time. The inventive process, therefore, additionally ensures compliance with any regulation or hospital policy against discrimination in the delivery of healthcare services to uninsured patients.

A color-coded copy of the patient data form may be placed on a clipboard with other forms employed in delivering healthcare services, such as a form to record triage information, and a form to record orders given by a doctor. A copy of the patient data form containing patient information is part of the patient's clipboard, the patient need not complete the registration process prior to triage, or prior to receiving an examination by a doctor.

Referring to FIG. 1, method 10 may include the step 12 of recording the time the patient arrived to receive healthcare services. This step may be performed by the greeter. The time of arrival may be recorded on the patient data form. In one embodiment, the time of arrival comprises indicia, such as a timestamp, impressed by a conventional automated time clock.

The greeter may perform additional services. The greeter may serve as a member of a triage team for the emergency department. The greeter may also enter patient information, such as the time of arrival, sex, birth date, and chief complaint, into a computer database or other computer program for patient management. Such data entered may additionally provide the basis for an automated patient log, and place the patient in a tracking system for the hospital. The greeter may also assist in inventorying the belongings of the patient.

Referring to FIG. 1, method 10 may include the step 14 of identifying the status of the condition of the patient. The patient may be classified as an emergent patient or a non-emergent patient. An emergent patient may include patients who present chest pains, difficulty with breathing, vaginal bleeding, stroke symptoms, head injuries, and other acute or potentially life threatening injuries or symptoms. Non-emergent patients may present non-life threatening injuries or symptoms, or have emergent conditions that are not readily apparent to the greeter. The greeter may identify the status of the patient upon the patient's arrival at emergency department 40, and may record the status on the patient data form.

Referring to FIGS. 1 and 2, the patient may be assigned to an area to receive healthcare services based on the identified status of the patient. An emergent patient may be assigned 26 to a first area such as treatment area 66. A non-emergent patient may be assigned 16 to a second area, such as non-emergent treatment area 54.

A non-emergent patient assigned to non-emergent treatment area 54 may be escorted to a specific non-emergent treatment room 56 in area 54. Alternatively, if no treatment room 56 is available, the non-emergent patient may be requested to wait in lobby 42 until such a treatment room 56 becomes available. The specific room 56 assigned to the non-emergent patient may be recorded on the patient data form.

Clipboards containing patient data forms for non-emergent patients may be placed in clipboard rack 64 in none-mergent treatment area 54. A color-coded copy of the patient data form may be placed on top of any additional forms held by the clipboard. The color of the copy of patient data forms for patients assigned to non-emergent treatment area may be a distinct color, such as yellow, to readily indicate the non-emergent status of such patients.

Referring to FIG. 1, method 10 may include step 18 wherein a doctor, who is assigned to non-emergent treatment area 54, examines non-emergent patients. The doctor assigned to non-emergent treatment area 54 may, and preferably does, have access to the clipboards arranged in clipboard rack 64. The doctor may then examine patients in area 54 in chronological order of the patients' time of arrival, which may be indicated on the patients' patient data forms. Alternatively, the doctor may choose to examine non-emergent patients in another order, such as by acuity, and may regard the patient's time of arrival as a non-determinative factor to consider in queuing the examination of patients.

With continued reference to FIGS. 1 and 2, method 10 may include the step 20 of recording the time that the doctor assigned to non-emergent treatment area 54 examines a non-emergent patient. The examination time may be recorded on the patient data form by the doctor, a nurse, or another member of the hospital staff. This time may be written by hand.

Referring to FIGS. 1 and 2, method 10 may include the step 22 of determining the location for treatment for a patient initially assigned to non-emergent treatment area 54. Step 22 may be performed by the doctor assigned to non-emergent treatment area 54. Non-emergent patients who may require additional healthcare services may be reassigned to treatment area 66, or another area in the hospital. Therefore, patients who were first examined by a doctor in non-emergent treatment area 54, may be examined by another doctor in emergent treatment area 66. Clipboards of charts and forms for non-emergent patients transferred to treatment area 66 may be reassigned with the patient, and placed in emergent area clipboard rack 76. The color of patient data forms for non-emergent patients transferred from area 54 to treatment area 66 are distinct from the color of patient data forms for other patients in clipboard rack 76.

Non-emergent patients who may require less significant healthcare services may remain in non-emergent treatment area 54. Prior to or concurrent with the determination of treatment location for non-emergent patients, medical tests or procedures may be ordered for a non-emergent patient, such as intravenous fluids, medications, x-rays, urinalyses, blood tests, and the like.

As detailed in FIG. 1, method 10 may include the step 24 of providing a non-emergent patient who has been designated to remain in non-emergent patient treatment area 54 with a plan of care. The doctor who examined the non-emergent patient may provide the plan of care in part or entirely. The plan of care may be based on the specific examination of the non-emergent patient by the doctor, and may include orders for treatment and medical tests.

With continued reference to FIGS. 1 and 2, method 10 may further include the step 26 of assigning patients initially identified as emergent to treatment area 66. An emergent patient assigned to treatment area 66 may be assigned to a specific room 68 or a specific bed 70 in treatment area 66. Similarly, an emergent patient who arrives by ambulance or other emergency vehicle may also be assigned to a specific room 68 or a specific bed 70 in treatment area 66. The specific room 68 or bed 70 assigned to the emergent patient may be recorded on the patient data form.

Clipboards containing patient data forms and charts for emergent patients may be placed in clipboard rack 76 in treatment area 66. A color-coded copy of the patient data form may be placed on top of any additional forms held by the clipboard. The color of the copy of patient data forms for patients assigned to treatment area 66 may be a particular color, such as pink. The color of the patient data form may distinguish emergent and other patients from patients who were transferred from non-emergent treatment area 54, and, therefore, who had been examined by the doctor assigned to non-emergent treatment area 54 prior to arriving at treatment area 66.

Referring to FIG. 1, method 10 may include the step 28 of a doctor, who is assigned to treatment area 66, examining emergent patients. The doctor assigned to treatment area 66 may have access to the clipboards arranged in clipboard rack 76. The doctor may then examine patients in area 66 in order of acuity of a patient's chief complaint, chronological order of the patients' time of arrival, or by another queuing system.

With continued reference to FIGS. 1 and 2, method 10 may include the step 30 of recording the time that a doctor assigned to treatment area 66 examines an emergent patient. The examination time may be recorded on the patient data form by the doctor, a nurse, or another member of the hospital staff. The time of examination by the doctor assigned to treatment area 66 may or may not be recorded for patients in area 66 who have been reassigned from non-emergent treatment area 54.

As detailed in FIG. 1, method 10 may include the step 32 of providing a plan of care to an emergent patient, or non-emergent patient who has been reassigned to treatment area 66. The doctor who examined the emergent patient may provide the plan of care in part or entirely. The plan of care may be based on the specific examination of the non-emergent patient by the doctor, and may include orders for treatment, and orders for medical tests.

With continued reference to FIG. 1, method 10 may include the step 34 of reviewing the time recorded for the examination time of the doctor for a patient. Method 10 may also include the step of determining whether the examination time of the doctor was more than a set period of time after the patient arrived at emergency department 40, for example, thirty minutes. Method 10 may further include the step of providing compensation to the patient if the patient was not examined by a doctor more than the predetermined amount of time after the patient's arrival. Such compensation may be in the form of, for example, complementary passes to a movie, coupons for complementary or discounted meals at a restaurant, and the like.

Under the inventive method, triage may have a less significant role in providing healthcare services to patients at an emergency department, due to the initial identification as to whether a patient is emergent or non-emergent. Nevertheless, a formal triage assessment may be easily integrated with the inventive method. Triage for non-emergent patients may be performed in non-emergent treatment area 54. Since these patients have been initially identified as non-emergent, triage may occur prior to, concurrent with, or after the examination by the doctor. For emergent patients, and patients assigned to treatment area 66, triage may also be performed prior to, concurrent with, or after an examination by a doctor. In addition, the triage assessment for patients assigned to treatment area 66 may be communicated through use of colored clipboards containing patient charts and forms, as for example the use of a red clipboard for the most acute patients and the use of a green clipboard for less severe patients. Accordingly, under the inventive method, a patient is not required to complete triage prior to receiving an examination from a doctor.

While the invention has been particularly shown and described with reference to the preferred embodiments thereof, it is well understood by those skilled in the art that various changes and modifications can be made in the invention without departing from the spirit and scope of the invention.

I claim:

1. In a hospital emergency department having a first doctor assigned to a first area to provide healthcare services to patients, a method for delivering healthcare services comprising the step of assigning a second doctor to a second area to provide healthcare services to non-emergent patients.

2. In a facility having a first area configured to provide healthcare services to patients, a method for delivering healthcare services comprising the steps of:
(a) providing a second area configured to provide healthcare services to non-emergent patients; and
(b) identifying whether a patient is non-emergent.

3. The method of claim 2, wherein the facility is a hospital emergency department.

4. The method of claim 2, wherein the identification is performed upon the arrival of the patient at the facility.

5. The method of claim 2, wherein the identification is performed by a medical clinician.

6. The method of claim 2, further comprising the step of providing a doctor to examine non-emergent patients in the second area.

7. In a facility having a first area configured to provide healthcare services to patients, a method for delivering healthcare services comprising the steps of:
(a) providing a second area configured to provide healthcare services to non-emergent patients;
(b) identifying whether a patient is non-emergent; and
(c) recording the time a patient arrives at the facility to receive healthcare services.

8. The method of claim 7, wherein the facility is a hospital emergency department.

9. The method of claim 7, wherein the identification is performed upon the arrival of the patient at the facility.

10. The method of claim 7, wherein the identification is performed by a medical clinician.

11. The method of claim 7, further comprising the step of providing a doctor to examine non-emergent patients in the second area.

12. The method of claim 7, further comprising the step of queuing non-emergent patients to receive the examination by the doctor by time of arrival.

13. In a facility having a first area configured to provide healthcare services to patients, a method for delivering healthcare services comprising the steps of:
(a) providing a second area configured to provide healthcare services to non-emergent patients;
(b) identifying whether a patient is non-emergent;
(c) recording the time a patient arrives at the facility to receive healthcare services; and
(d) providing the patient a form of compensation when the patient first receives healthcare services more than a predetermined time after the patient's arrival.

14. The method of claim 13, wherein the facility is a hospital emergency department.

15. The method of claim 13, wherein the identification is performed upon the arrival of the patient at the facility.

16. The method of claim 13, wherein the identification is performed by a medical clinician.

17. The method of claim 13, further comprising the step of providing a doctor to examine non-emergent patients in the second area.

18. The method of claim 17, further comprising the step of queuing non-emergent patients to receive the examination by the doctor by time of arrival.

19. The method of claim 13, wherein the form of compensation is provided to the patient when the patient has first been examined by a doctor more than a predetermined time after the patient's arrival.

20. In a hospital emergency department having a first area configured for a doctor to provide healthcare services to patients, a method for delivering healthcare services comprising the steps of:
(a) assigning a first doctor to provide healthcare services to patients in the first area;
(b) providing a second area configured to provide healthcare services to non-emergent patients;
(c) assigning a second doctor to provide healthcare services to patients in the second area; and
(d) identifying whether a patient is non-emergent upon the arrival of the patient at the facility.

21. The method of claim 20, wherein the identification is performed by a medical clinician.

22. The method of claim 20, further comprising the step of recording the time the patient arrives at the facility to receive healthcare services.

23. The method of claim 22, further comprising the step of queuing non-emergent patients to receive healthcare services by the second doctor by time of arrival.

24. The method of claim 22, further comprising the step of providing the patient a form of compensation when the patient first receives healthcare services more than a predetermined time after the patient's arrival.

25. The method of claim 24, wherein the form of compensation is provided to the patient when the patient first receives healthcare services from the first or second doctor more than a predetermined time after the patient's arrival.
